(19) United States
(12) Patent Application Publication
(10) Pub. No.: US 2018/0261047 A1
(43) Pub. Date: Sep. 13, 2018

(54) GAMING SYSTEMS AND METHODS FOR ALLOWING PLAYERS TO USE GAMING CREDITS FOR NON-WAGERING PURPOSE

(71) Applicant: GREGORY R. ZILBA, SYLVANIA, OH (US)

(72) Inventor: GREGORY R. ZILBA, SYLVANIA, OH (US)

(21) Appl. No.: 15/976,837

(22) Filed: May 10, 2018

Related U.S. Application Data
(63) Continuation of application No. 14/027,133, filed on Sep. 13, 2013, now abandoned.
Application No. 14/027,133 is a continuation-in-part of application No. 13/385,141, filed on Feb. 3, 2012, now abandoned.
(60) Provisional application No. 61/457,224, filed on Feb. 4, 2011.

(51) Int. Cl. G07F 17/32

(52) U.S. Cl. CPC G07F 17/3244; G07F 17/3255

(57) ABSTRACT

A gaming device and method of playing a game of chance that includes the steps of providing a game of chance on a first gaming device, allowing a first player to obtain a gaming credit, displaying on a display device a plurality of categories of charitable organizations, each of the categories including a charitable organization, allowing the first player to select a category and a charitable organization within the category, and allowing the first player to donate the gaming credit to the charitable organization.

### CROSS-REFERENCE TO RELATED APPLICATIONS

This application claims priority from and is a continuation application of U.S. application Ser. No. 14/027,133 filed Sep. 13, 2013. U.S. application Ser. No. 14/027,133 is a continuation-in-part of U.S. application Ser. No. 13/385,141 filed Feb. 3, 2012, which claims the benefit of a U.S. provisional application Ser. No. 61/457,224 filed Feb. 4, 2011, the disclosures of which are hereby incorporated in their entirety by reference herein.

### TECHNICAL FIELD

This disclosure relates to gaming devices that allow players use gaming credits for non-wagering purpose.

### BACKGROUND

Playing gaming devices found in casinos, such as slot machines and video poker machines, involve depositing currency or gaming voucher into a bill acceptor, playing a game of chance, and obtaining a game outcome wherein the player either wins or lose. The player may play several times until the player quits and collects any remaining money in the gaming device, or the player runs out of money.

Gaming devices that allow players to designate a portion of their wagers or winnings to be donated to a third party are disclosed in Herrington's US Patent Application Publication Number 2009/0209327. It is desirable for these gaming devices to have systems and methods that would encourage players to make donations, as well as systems and methods that would allow players to have more interaction with each other or with the gaming devices.

The above problems and other problems are addressed by this disclosure as summarized below.

### SUMMARY

An aspect of the present disclosure relates to a method of playing a game of chance. The method includes the steps of providing a game of chance on a first gaming device, allowing a first player to obtain a gaming credit, and displaying on a display device a plurality of categories of charitable organizations. Each of the categories includes a charitable organization that can receive the gaming credit. The method further includes the steps of allowing the first player to select a category and a charitable organization within the category and allowing the first player to donate the gaming credit to the charitable organization.

Other aspects of the method of playing a game of chance include: a providing a second gaming device for a second player and allowing the first player to make a donation on behalf of the second player on the first gaming device; emailing the first player a receipt of the gaming credit donated to the charitable organization; displaying on the display device an incentive for players to make a donation on the gaming device; displaying on the display device a thank you message to players making a donation; displaying on the display device a plurality of selectable denominations representing amounts players can choose to donate; or allowing players to specify an amount of gaming credits they want to donate.

Another aspect of the present disclosure relates to a method of allowing players to play games of chance that includes the steps of allowing a first player to obtain a game credit and to play a game of chance on a first gaming device that is in communication with a second gaming device and allowing a second player to obtain a game credit and play a game of chance on the second gaming device. The method further includes the step of crediting the second player for making a donation that was donated by the first player on behalf of the second player.

Other aspects of the method of allowing players to play games of chance include: displaying on a display device an announcement that the first player donated on behalf of the second player, providing the first player an incentive coupon to encourage the first player to donate again, emailing the first player with a donation receipt, displaying on a display device a thank you message to the first player, or providing the player a choice of whether to manually enter a donation amount or to select one pre-defined donation amount from a plurality of pre-defined donation amounts.

Another aspect of the present disclosure relates to a gaming device for providing a game of chance to a player. The gaming device includes a currency validator to accept an acceptable gaming currency and to convert the gaming currency into a gaming credit. The gaming device further includes a player tracking module for tracking length of play of the player and amount of wager by the player. The player tracking module may include a memory for storing historical game data for the player and a processor for determining loyalty points for the player based on the player's game data. The gaming device also includes a player tracking interface having an input device connected to the player tracking module for allowing the player to input the player's preference of a product and an output device for displaying loyalty points earned by the player. The gaming device further includes a donation server in communication with the player tracking module for allowing the player to donate the gaming credit to a charitable organization. The donation server may provide a coupon to the player for donating the gaming credit.

Other aspects of the gaming device include a donation server having a memory that stores a database of charitable organizations. The charitable organizations may be grouped into various categories. The donation server is configured to prompt the player to provide an instruction on how the player wants to split the gaming credit among the charitable organizations and to split the gaming credit according the player's instruction. The donation server can be configured to split the gaming credit equally among all the charitable organizations in its database. The donation server may be configured to email the player a confirmation of a donation, or to send a thank you greeting to a player after the player makes a donation.

Another aspect of the gaming device includes an interface board connected to a gaming system that is connected to a plurality of gaming devices. The donation server is configured to accept a player's donation and transfer the player's donation to another player of one of the plurality of gaming devices connected to the gaming system.

The above aspects and other aspects of this disclosure are described below in greater detail with reference to the attached drawings.

### BRIEF DESCRIPTION OF THE DRAWINGS

FIG. 1 is a schematic diagram of a gaming system for executing the gaming methods of the present disclosure.

FIG. 2 is a flowchart showing an aspect of the gaming method that allows players to make a donation on behalf of other players.

FIG. 3 is a front view of a cash out, donate, or purchase screen configured to be displayed on a display device of the gaming system.

FIG. 4 is a flowchart showing an aspect of the gaming method that allows players to select a charitable organization and donate some or all of their gaming credits.

FIG. 5 is a front view of a category select screen providing a variety of categories of charitable organizations to a player.

FIG. 6 is a front view of an organization select screen providing a selection of charitable organizations to the player.

FIG. 7 is a front view of a charity information screen providing a description of a charitable organization to the player.

FIG. 8 is a flowchart showing an aspect of the gaming method allowing players to donate and providing confirmations of the donations of the players.

FIG. 9 is a front view of a donation amount screen allowing a player to pick a charity and an amount to donate.

FIG. 10 is a front view of a screen with an on screen keyboard for allowing players to enter their email addresses.

FIG. 11 is a flowchart showing an aspect of the gaming method providing offers or coupons to players to encourage them to donate.

FIG. 12 is a flowchart showing an aspect of the gaming method thanking players for their donations.

FIG. 13 is a flowchart showing an aspect of the gaming method allowing players to purchase an item using their gaming credits.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

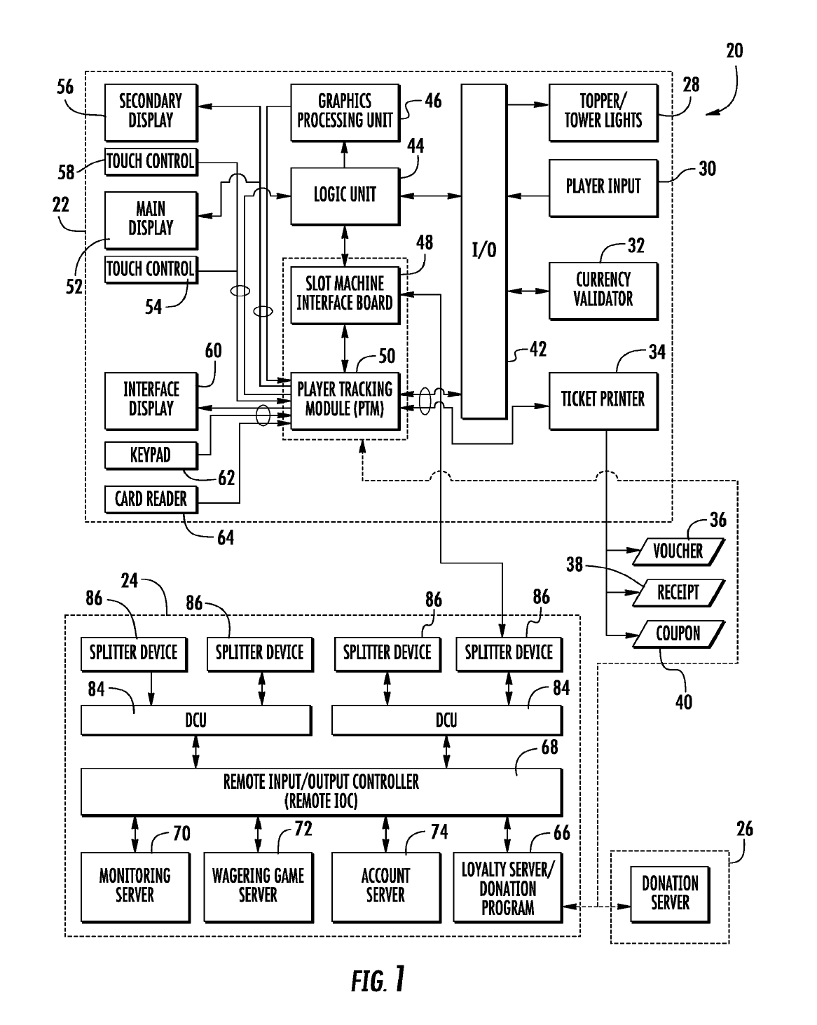

FIG. 1 is an exemplary gaming system 20 that includes one or more gaming devices 22 connected to a central controller 24 and an optional donation server 26. The gaming devices 22, the donation server 26, and the central controller 24 may be connected via a communications network that may utilize wires or wireless medium known in the art. The gaming devices 22 include various external input and output devices or peripheral devices, such as a plurality of lights 28, player input devices 30, such as touch screens, keypads, and slot machine handle, a currency validator 32 for accepting and validating gaming vouchers, bills, credit cards, pre-paid cards, or debit cards inserted by players to place a wager on the gaming device, and a ticket printer 34 for printing vouchers 36, receipts 38, and coupons 40, and an input/output controller 42. The input/output controller 42 interfaces between the input and output devices and the logic board 44 to enable communication among them and to coordinate their operations. The logic board 44 implements a programming logic of one or more games that may originate from the central controller 24 and controls the operation of the hardware and software of the gaming device 22.

The logic board 44 preferably includes a graphic processing unit 46, a slot machine interface board 48, and player tracking module 50. The player tracking module 50 may be connected to: a main display 52 and a main display touch control 54; a secondary display 56 and a secondary display touch control 58; and an interface display 60 with its keypad 62 and card reader 64. The main display 52, secondary display 56, and interface display 60 may be any display devices known in the art, including CRT, LCD, and plasma. The graphic processing unit 46 processes various video images or game presentations and sends them to the main display 52, secondary display 56, or interface display 60. The video images or game presentations may pass through the player tracking module so that video images or game presentations relating to the donation aspect of the gaming method described below may be synchronized with those of the games.

One or more games of chance may be provided to the players, and the games of chance may be displayed on or more of the display devices 52, 54, or 60. At least one of the display devices 52, 54, or 60 preferably serves as a donation screen where certain steps of the exemplary methods of allowing players to make a charitable donation using their gaming credits and managing the charitable donations as further described below is displayed.

The slot machine interface board 48 allows the gaming device 22 to work with other gaming machines that are connected to the central controller 24. For instance, as described further below, when a player wants to make a donation on behalf of the other player on a separate gaming device but connected to the controller 24, the slot machine interface board provides the communication between the two gaming devices so the other player can be informed of the donation made on his behalf and he can be credited for the donation.

The player tracking module 50 communicates with the central controller 24 to track and save players' gaming habits, such as the frequency of the players' participation in the games, the amount the players' wager, players' winnings or losses, the amount of loyalty points players have accumulated, players' profiles that may include players' contact information, preferences of consumer products or services, and the like. Alternatively, the player tracking module 50 may have its own memory and processor. The player tracking module 50 may be connected to the ticket printer 34 so the ticket printer 34 can print coupons and marketing materials based on the player's gaming history, gaming performance, and profile. An exemplary ticket printer 34 can be an Epicentral® print system from Transact Technologies Incorporated of Hamden, Conn. The player tracking module 50 is also optionally connected to the donation server 26 and a loyalty server 66 to allow the gaming system to initiate one or more donation processes described below and to add the players' donations into the players' gaming habits.

The central controller 24 includes a remote input/output controller 68. The remote input/output controller 68 is connected to various servers, including a monitoring server 70, wagering game server 72, and an account server 74. The remote input/output controller 68 is configured to route communications from the various servers to a data control unit 84. The monitoring server 70 monitors the status and activity of each gaming device. The wagering game server 72 stores various games to be sent to the gaming machines and may execute various programs to conduct the games. The account server 74 tracks player credits and transactions for each of the gaming device.

The input/output controller 68 is preferably connected to one or more data control units (DCUs) 84. Each DCU is configured to manage data transmissions between the remote input/output controller 68, the slot machine interface board 48, and the peripheral devices. The DCUs 84 are connected to one or more splitter devices 86. The splitter devices 86 split the resources of the various servers—the monitoring server 70, wagering game server 72, account server 74, and the loyalty server 66—of the central controller 24 so they can be made available to various gaming devices 22 connected to the central controller 24. The splitter device 86 also link gaming device together as well as their peripherals on the same network communication line. The gaming system 20 is an exemplary gaming system and may be varied by using only some components, by providing additional components, or substituting some of the components.

Before discussing the gaming methods of the present disclosure or any of the flowcharts included in the present application, it is to be understood that the order in which the steps are presented is not limited to any particular order and does not necessarily imply that they have to be performed in the order presented. It will be understood by those of ordinary skill in the art that the order of these steps can be rearranged and performed in any suitable manner. It will be further understood by those of ordinary skill in the art that some steps may be omitted or added and still fall within the spirit of the invention.

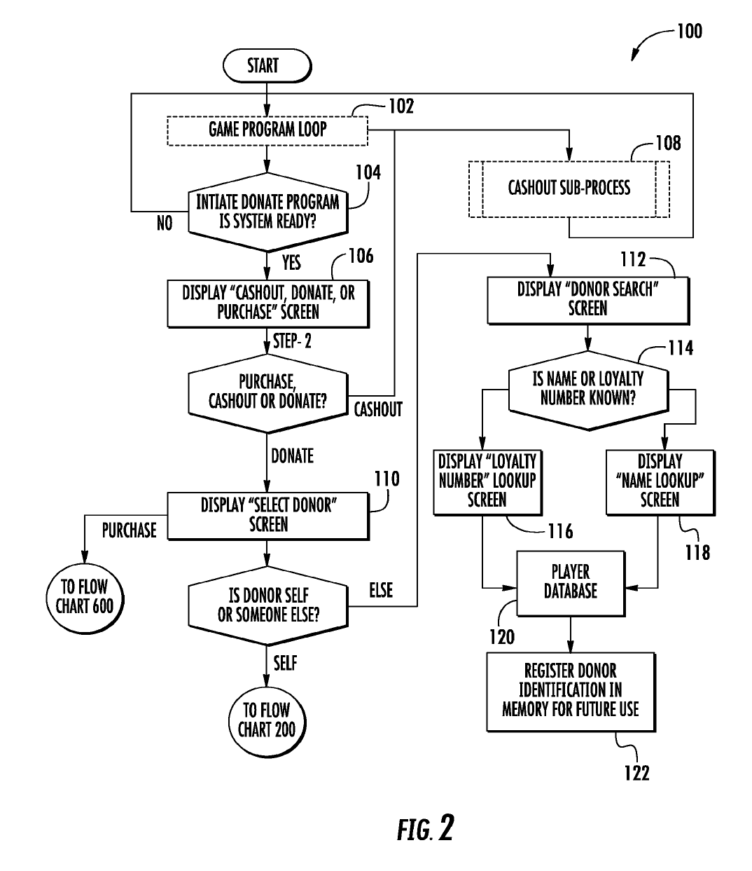

The gaming methods will be discussed starting with flowchart 100 shown in FIG. 2. At step 102, a player plays a game of chance on a gaming device. The game of chance may be a slot machine, video poker, casino games in video form, such as roulette, craps, and blackjack, and other games of chance known in the art. The player starts by placing a wager, such as by inserting cash or gaming voucher into the currency validator 32. The gaming system 20 initiates the donation program (step 104). In certain embodiments, the donation program is initiated when the cash or gaming voucher is converted into gaming credits. In certain embodiments, the donation program is initiated when the cash or gaming voucher is converted into gaming credits and the game has finished. For instance, where the game is slots, the game is considered finish when the reels have stopped and the outcome has been determined.

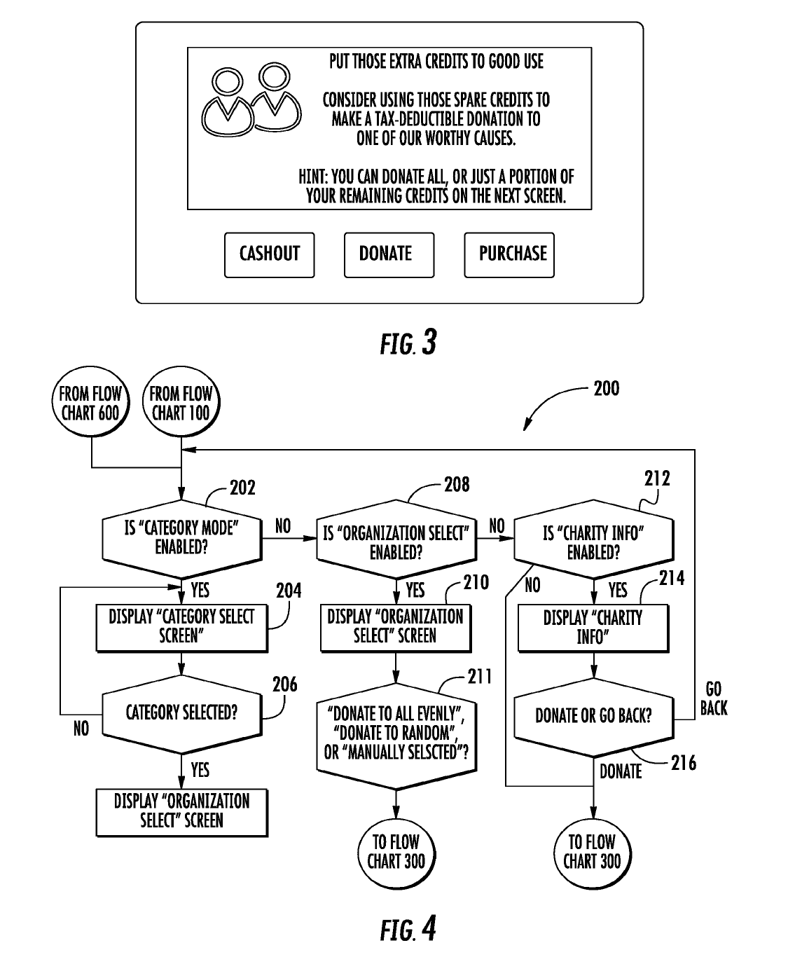

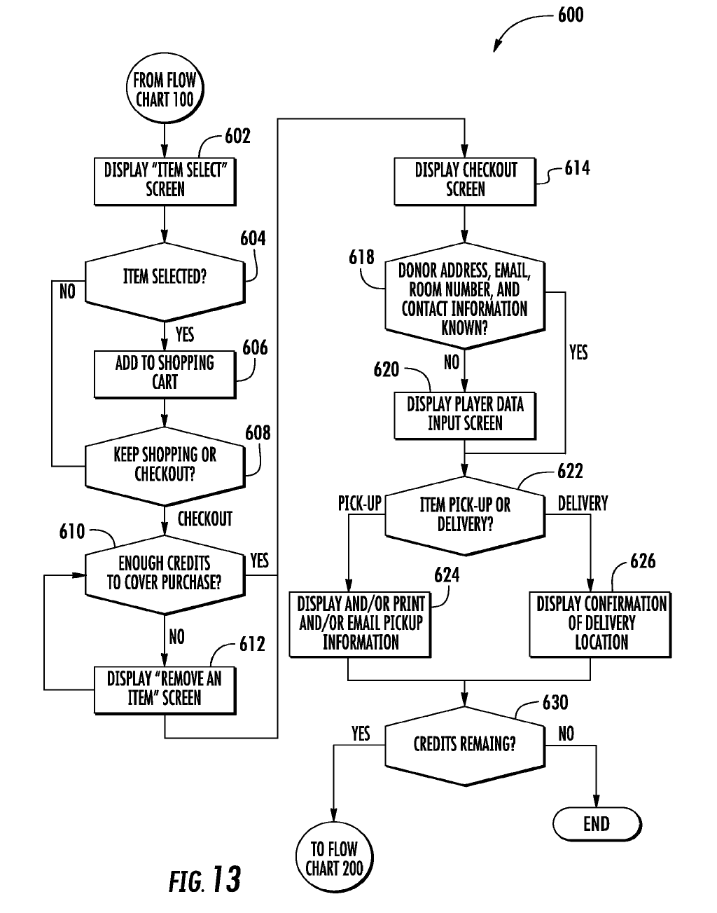

A screen prompting the player to indicate whether he wants to cash out, donate, or purchase is displayed (step 106). A sample of the screen is shown in FIG. 3. The screen may be shown on the main display 52, the secondary display 56, or the interface display 60 of the gaming device 22. Referring back to FIG. 2, if the player wants to cash out, the gaming system 20 executes a cash out process (step 108) and dispenses the player's gaming credits that may be in a form of a voucher. If the player wants to make a purchase with his gaming credits, the gaming system 20 executes the steps of flowchart 600 shown in FIG. 13. If the player wants to make a donation, a “select donor” screen is displayed prompting the player to indicate whether he is the donor or he is making a donation on somebody's behalf (step 110). If the player wants to donate on behalf of somebody, a “donor search” screen is displayed (step 112). The “donor search” screen asks for a name of the donor or a loyalty/player tracking number of the donor. The gaming system 20 may display a “loyalty number” look up screen (step 116) or a “name” look up screen for the player to find the donor (step 118). The gaming system 20 preferably searches the player database from the loyalty server 66 to see if the donor can be found based on the name or loyalty number (step 120). If the name or the loyalty number cannot be found in the player database, the loyalty server 66 preferably stores the donor identification in its memory to register the donor for future use (step 122). Once the name of the donor is found or the donor is registered, the steps of flowchart 200 are executed. The player may select the charity and the amount to be donated on behalf of the other player. The player's gaming credits is used for the donation. The other player for whom the donation was made is notified preferably via a message displayed on one of the display devices of the gaming device he is playing. Both players may receive an email or print confirmation of the donation. Both players may receive an incentive coupon for the donation, as further discussed below. Both players may receive a thank you message displayed on their respective display devices, as further discussed.

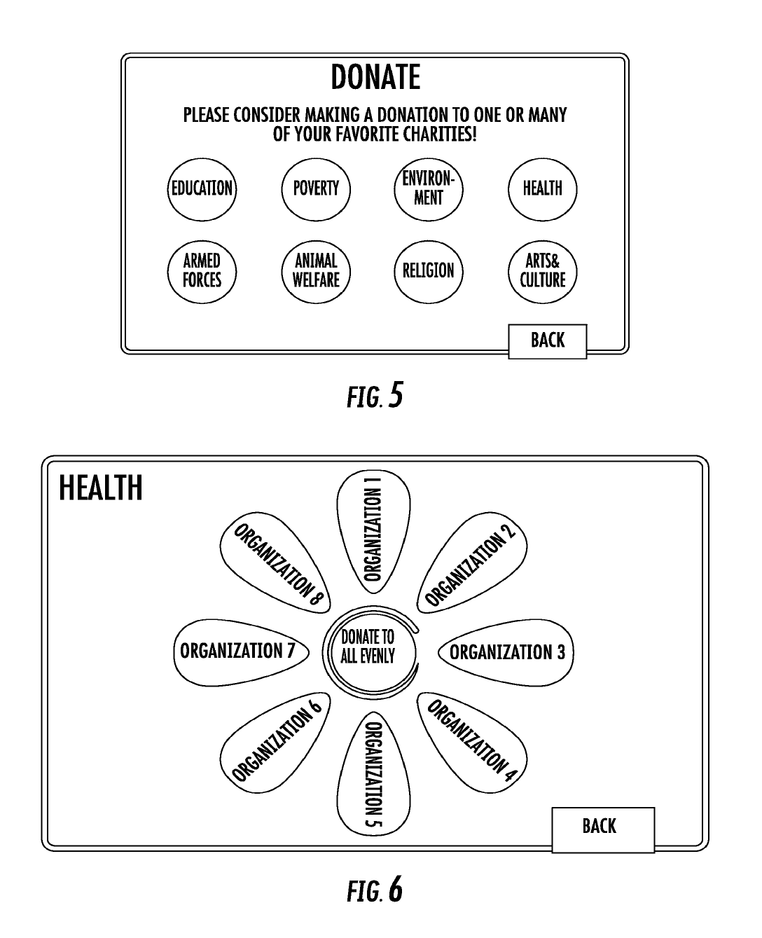

Referring to flowchart 200 shown in FIG. 4, if the player is the actual donor, the name of the donor is found or the donor is registered, the gaming system 20 displays either a category of charitable organizations, a selection of charitable organizations, or information about a single charitable organization, depending on the system setting. If the system setting has the category mode enabled (step 202), the “category select” screen is displayed (step 204), such as the one shown in FIG. 5. The category screen may be a touch screen that shows various categories of charitable organizations, such as education, poverty, environment, health, armed forces, animal welfare, religion, and arts and culture.

Referring back to FIG. 4, if a category has been selected (step 206) or if the system setting has the organization select mode enabled (step 208), an “organization select” screen is displayed (step 210). An exemplary “organization select” screen is shown in FIG. 6. The “organization select” screen may have various organizations listed or arranged in a desired orientation. The various organizations may all belong to one category, such as health, as shown. The various organizations may be listed on various flower petals arranged to form a flower. In the middle of the flower, a “donate to all evenly” button may be provided to allow players to split the gaming credits to be donated evenly to all the charitable organizations listed, as further discussed. At step 211, the player may be given an option whether to donate to all organizations listed evenly, randomly, or the player may manually select which organization should receive the donation. The gaming system 20 then executes the steps of flowchart 300.

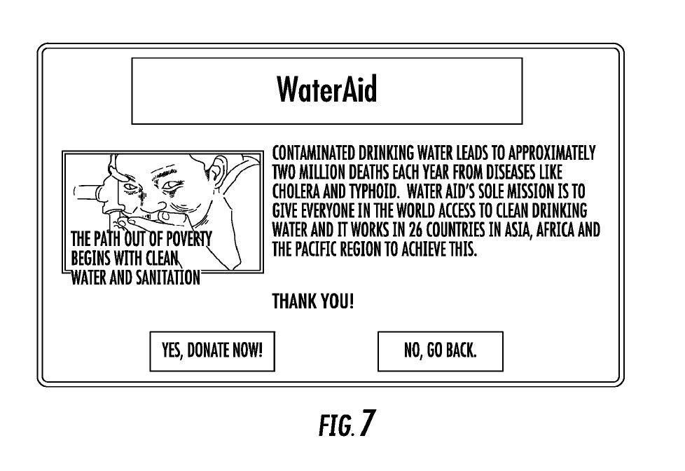

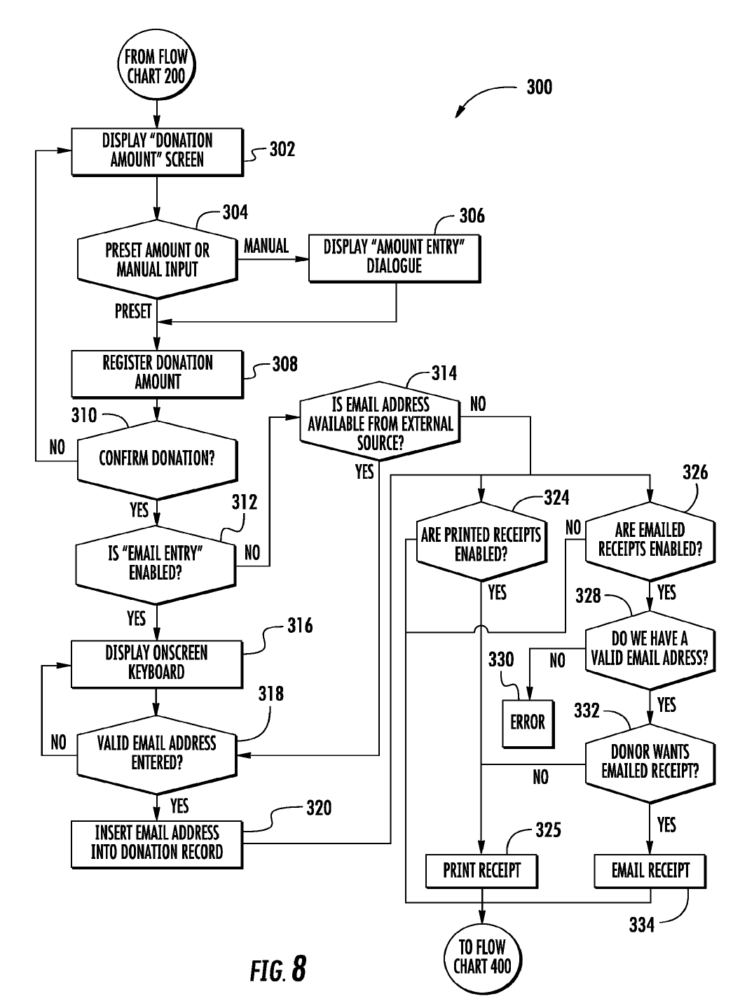

If the system setting has the charity info enabled (step 212), information about the charity is displayed (step 214). FIG. 7 shows an exemplary screen shot of the display showing information about the charity. The display includes a description about the charity, descriptive picture, and option boxes allowing the users to donate or to go back to previous screen. Referring back to FIG. 4, at step 216, the gaming system 20 waits for the player to select whether to donate or go back to step 202. If the player selects to donate, the gaming system 20 executes the steps shown in flowchart 300 of FIG. 8 wherein the appropriate donation amount is split among organizations depending on the player's instructions and appropriate donation confirmations are sent.

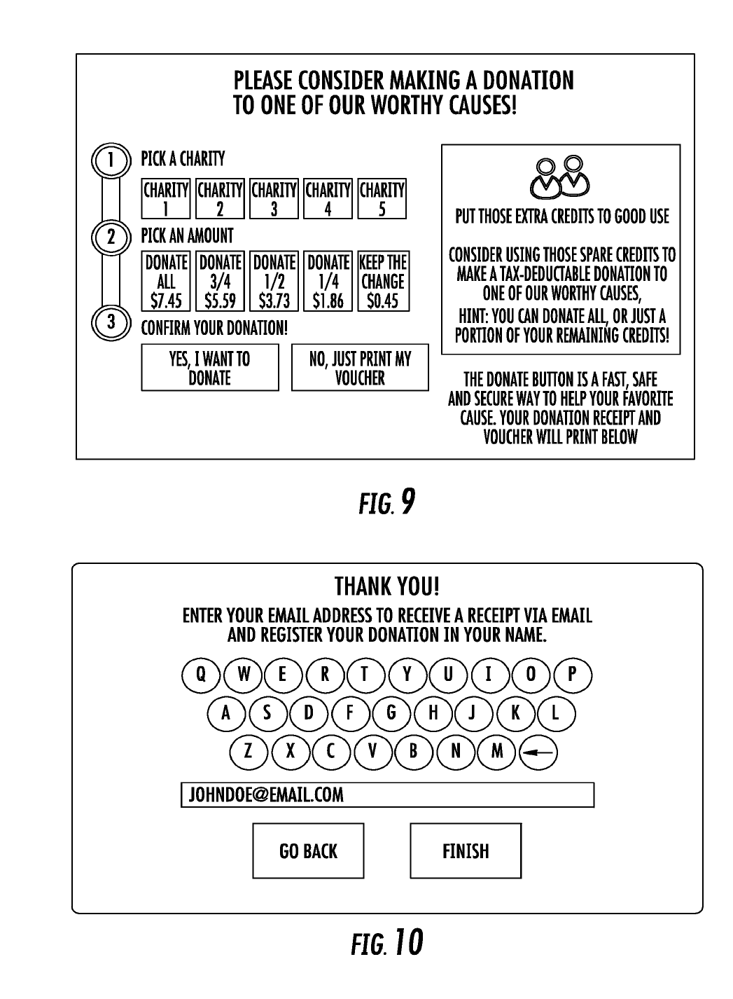

Referring to the flowchart 300 of FIG. 8, the donation amount designation process and the donation confirmation process are shown. At step 302, a donation amount screen is displayed. The player is given a choice whether to use a preset donation amount or manually enter a donation amount (step 304). If the player chooses to manually enter a donation amount, an amount entry dialogue screen is displayed providing, for instance, a virtual form where the player can input a donation amount (step 306). The donation amount is then registered in the gaming system 20 (step 308). If the player chooses to enter a preset donation amount, the gaming system 20 proceeds to register the donation amount (step 308). Next, the player is asked to confirm the donation (step 310). If the player does not confirm the donation, the method loops back to displaying the donation amount screen (step 302). An exemplary donation amount screen is shown in FIG. 9. The donation screen may include a listing of the charitable organizations for the players to select and a variety of donation amounts. The donation amounts may be the full remaining gaming credits, several fractions of the gaming credits e.g. ¾, ½, ¼, etc. . . . , or a specified amount. The donation screen may include a confirmation section where the player can choose to confirm the donation or just cash out.

Referring back to FIG. 8, once the player confirms the donation, the method checks whether a manual email entry mode is enabled 312. If not enabled, the method searches an external database for the donor's email address (step 314). If the email address is found, the method checks if the email address is valid at step 318. If the email address is valid, the email address is entered into the gaming system 20 (step 320). If the email address is not found, the method proceeds to step 324 to see if a print mode is enabled in the gaming system 20.

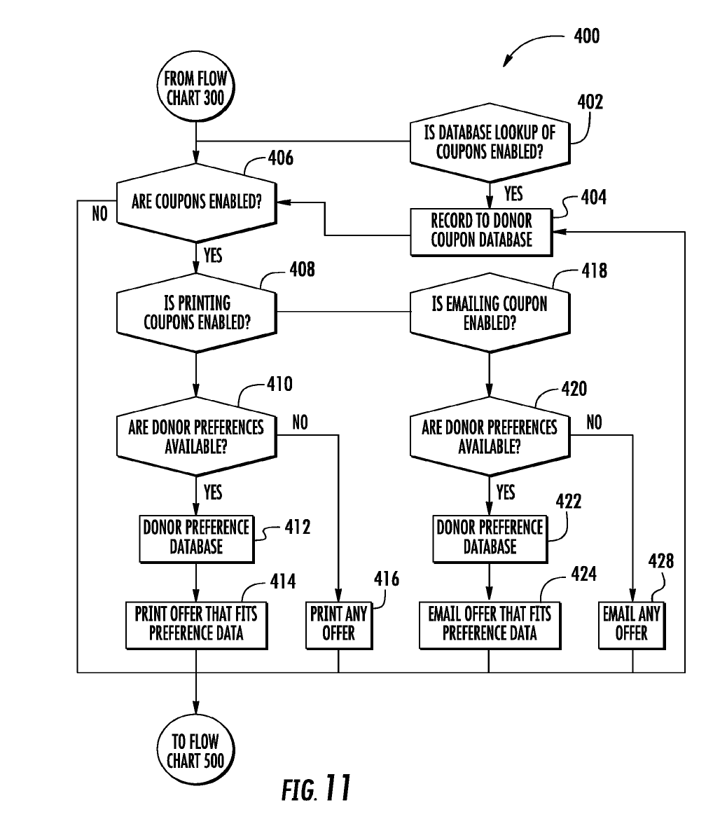

If the manual email entry mode is enabled, an on-screen keyboard is displayed at step 316. The method checks if a valid email address was entered by the player at step 318. If a valid email address was entered, the email address is entered into the gaming system 20 (step 320). An exemplary on-screen keyboard display is shown in FIG. 10 that includes a thank you message thanking the player for making a donation, a keyboard, and option keys for the player to go back to a previous display or finish entering the email address.

After the email address has been entered into the gaming system 20, the method checks whether the gaming system 20 is configured to print donation receipts at step 324 or to email donation receipts at step 326. If the gaming system 20 is configured to print donation receipts, the ticket printer 34 prints the donation receipt at step 325. If the gaming system 20 is not configured to print donation receipts, or if the gaming system 20 is configured to email donation receipts, the gaming system 20 may check again the validity of the email address at step 328. If the email address is not valid, the gaming system 20 displays an error message at step 330. If the email is valid, the method asks the player if the player wants his donation receipt emailed at step 332. If the player indicates yes, the donation receipt is emailed to the email address the player provided at step 334. If the player does not want the donation receipt emailed, the donation receipt is printed at step 325.

The method may include a way to encourage players to donate, such as by giving the players who donate coupons for use to obtain discounts or free merchandise. Flowchart 400 shown in FIG. 11 shows the aspect of the method for encouraging donations. At step 402, the method checks if the gaming system 20 is configured to look up a database of coupons and match the coupons with the player's profile. If it is configured, then the coupons found to match the player's profile is recorded into a donor coupon database (step 404).

The method checks if the gaming system 20 is configured to give out coupons at step 406. The gaming system 20 may be configured to give out coupons after a player has made a donation. If the gaming system 20 is configured to give out coupons, the method checks if the system is configured to print out coupons at step 408. If it is, then the methods checks if donor preferences exists at step 410. If they exist, then the method checks the donor preference database at step 412. The method proceeds to printing an offer or coupon that fits the preference of the donor at step 414. If the donor does not have a predefined preference, then the method prints any coupons or offers at step 416. If the system is not configured to print out coupons, the method checks if the system is configured to email coupons at step 418. If it is, then the method checks if donor preferences are available at step 420. If yes, then the method checks the donor preference database at step 422. Next, the method emails offers or coupons that fit the donor's preference at step 424. If the donor preferences are not available, then the method emails any offers or coupons to the donor at step 26.

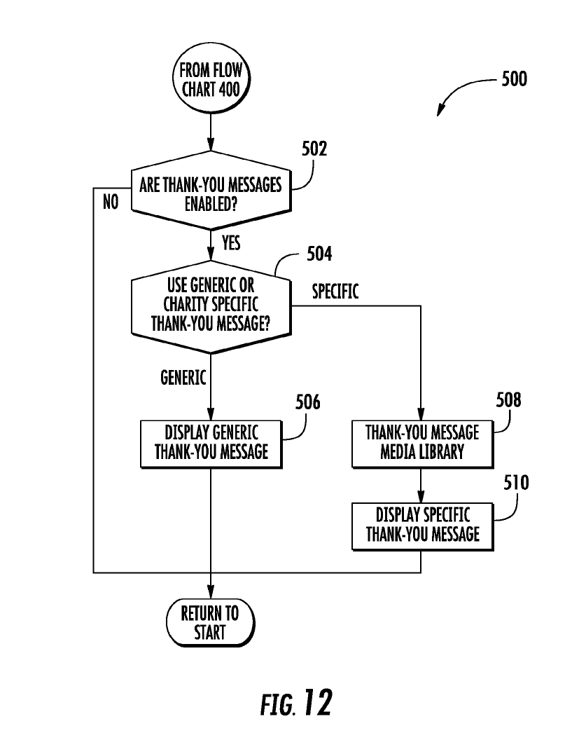

Referring to FIG. 12, the method may include steps for thanking the donors, such as the steps shown in flowchart 500. At step 502, the method checks if the system is configured to send thank you messages to donors. If it is, the method checks if the system is set to send generic or specific thank you message at step 504. If generic, the system displays a generic thank you message to the player or donor. If specific, the system checks the media library for a specific thank you message at step 508 and selects a specific thank you message. The specific thank you message is then displayed for the player or donor at step 510.

Referring to FIG. 13, a flowchart 600 showing the steps involved in allowing a player to make a purchase from the gaming system using his gaming credits is provided. At step 602, a screen showing items available for purchase is preferably displayed to the player. The method determines whether an item has been selected at step 604. If not, the method continues displaying items available for purchase. If an item has been selected, the selected item is added to a virtual shopping cart at step 606. Next, the player is prompted whether he wants to continue shopping or he wants to checkout (step 608). If the player wants to continue shopping, the method loops back to step 602 where the screen showing items available for purchase is displayed. If the player wants to checkout, the method checks whether the player has enough gaming credits to cover the purchase at step 610. If the gaming credits are insufficient, a screen showing that the item will be removed is shown to the player (step 612). Alternatively, the screen may give an option to the player to insert gaming vouchers, cash, credit or debit card to add more gaming credits.

If the player has sufficient gaming credits to cover the purchase, a checkout screen is displayed to the player (step 614). The method checks if the system has a record of the player's address, email, delivery address (such as a room number in the casino) and contact information (step 618). If there is no such record, a player data input screen is shown and may include a form for the player to complete and provide his address, email, delivery address and contact information (step 620). If the record is already complete, the method prompts the player to instruct the system whether to deliver the item purchased or allow the player to pick up the item (step 622). If the player wants to pick up the item, the method displays, prints, or emails the pick up location, date, and time (step 624). If the player wants the item delivered, the method displays a confirmation of the delivery location at step 626. At step 630, the method may check again on the amount of the player's gaming credits. The method may invite the player to make a donation, cash out, or purchase if the player has remaining credits.

The method may also include ways to encourage patrons to play the gaming devices and to notify patrons of the opportunity to make a charitable donation using the gaming devices. For instance, the gaming system may be programmed to enable on-screen graphics and lighted indicators on terminal. The gaming system may be programmed to enable terminal and bank audible indicators or communication with external audible or visual indicators.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A gaming system for providing a game of chance to players, the gaming system comprising:
a first gaming device for use by a first player, the first gaming device including a player tracking module connected to a memory for storing game data for the first player;
a second gaming device for use by a second player, the second gaming device including
a currency validator programmed to accept an acceptable gaming currency and to convert the gaming currency into a gaming credit,
a player tracking module programmed to track length of play and amount of wager by the second player, the player tracking module connected to a memory for storing game data for the second player and a processor for determining loyalty points for the second player based on the game data, and
a player tracking interface having
an input device connected to the player tracking module of the second gaming module programmed to allow the second player to find the first player and
an output device programmed to display loyalty points earned by the second player; and
a donation server communicating with the player tracking module of the first and second gaming devices, wherein the donation server is programmed to allow each player to make a charitable donation using the gaming credit to a charitable organization and to allow the second player to record the charitable donation to the game data of the first player.

2. The gaming device of claim 1, wherein the donation server has a memory device that stores a database of charitable organizations, and wherein the donation server is programmed to prompt the players to provide an instruction on how the players want to split the gaming credit among the charitable organizations and to split the gaming credit according the instruction.

3. The gaming device of claim 1, wherein the donation server is programmed to email the players a confirmation of a donation.

4. The gaming device of claim 1, wherein the donation server is programmed to send a thank you greeting to the players after the players make a donation.

5. The gaming device of claim 1, further comprising an interface board connected to a gaming system, the gaming system connected to a plurality of gaming devices, wherein the donation server is programmed to accept the players' charitable donation and to transfer the players' charitable donation to another player of one of the plurality of gaming devices connected to the gaming system.

6. The gaming device of claim 1, wherein the charitable organizations are grouped into various categories.

7. The gaming device of claim 2, wherein the donation server is programmed to split the gaming credit equally among all the charitable organizations in its database.
